(19) United States
(12) Patent Application Publication
(10) Pub. No.: US 2008/0201292 A1
(43) Pub. Date: Aug. 21, 2008

(54) Method and apparatus for preserving control information embedded in digital data

(75) Inventors: Wolfgang Roethig, San Jose, CA (US); Chia Lun (Chuck) Hang, Morgan Hill, CA (US)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Integrated Device Technology, Inc.

(21) Appl. No.: 11/708,647

(22) Filed: Feb. 20, 2007

(51) Int. Cl. G06F 17/30

(52) U.S. Cl. 707/1; 707/E17.031

(57) ABSTRACT

Control information embedded in digital data is preserved by inputting digital data into a data processor, wherein the digital data includes real-time samples of recorded data and control information, the control information being organized in a format within the digital data, separating at least some of the control information from the recorded data, and storing the separated control information in a memory so that it is preserved.

### BACKGROUND OF THE INVENTION

In a digital audio transmission scheme, data is organized in frames and blocks. A frame represents a set of M data bits, corresponding to one instance of time. A block represents a set of N consecutive frames, corresponding to N consecutive instances of time. The duration of one instance of time is defined by the audio sampling frequency fₛ. For example, if fₛ=100 KHz, one hundred thousand blocks would be transmitted during one second. Therefore, one instance of time would be 10 microseconds. The data contained in one frame consists of (1) a sample of audio data (K bits), and (2) a set of non-audio data (M-K bits).

The purpose of the non-audio data is to control, synchronize, or otherwise support the rendering of the audio data in a receiver. In general, the non-audio data needs to be considered in the context of an entire block, not only in the context of a particular frame. The semantics of the data depend on the position of data within a frame and of the position of a frame within a block. The detailed format of data organization for a digital audio transmission scheme may be defined in a standard, such as IEC 61958-1. However, the invention presented herein is not restricted by a particular standard.

It is often desirable that the rate of audio data be changed in the digital domain before rendering the received data in the analog domain. For example, a device for digital audio processing may have insufficient memory allocated for the storage of incoming data. Therefore, the amount of data should be reduced, i.e., decimated. On the other hand, a device for digital audio processing may expect a higher amount of data than the actually incoming data. Therefore, the amount of data should be increased, i.e., interpolated.

Decimation and replication of audio data (or any other band-limited real-time data for that matter, such as video data, digitized measurement data) does not pose a problem, as long as proper filtering is applied. The theory of digital signal processing teaches what filtering methods are applicable. However, no such method can be applied to the non-audio data. Any bit omitted, inserted, or otherwise altered will render this data meaningless.

Digital receivers rely on the integrity of the non-audio data. Such data conveys necessary information for properly rendering the audio data. For example, IEC 61958 defines category code (the kind of equipment used, e.g. compact disk, digital tape recorder, digital broadcast receiver), channel number (2 channels in stereo mode, up to 8 channels in surround sound mode), clock accuracy and other relevant information. Therefore, data subjected to decimation and/or replication is no longer suitable for rendering when using a digital receiver. A method is proposed in the present application to preserve the integrity of the non-audio data in the context of digital audio transmission wherein the audio data is subject to decimation and replication.

One way of dealing with the non-audio data is simply to discard it. Tests have been conducted regarding the behavior of a commercial device supporting two audio output formats, namely SPDIF and I2S. The SPDIF output carries along the non-audio data, whereas the I2S output does not. When the audio data was intentionally altered (i.e., decimated or interpolated), the sound on the SPDIF output was frequently interrupted, whereas the sound on the I2S was uninterrupted. This simple method excludes the usage of state-of-the-art equipment supporting SPDIF.

Another way of dealing with the non-audio data is to redefine it before rendering, using software. The builder of the audio system has to program suitable data into the audio processor. This method works only in a closed system, i.e., knowledge of suitable data is somehow available through other means than the transmitted data.

Another way of dealing with the non-audio data is to limit the usage of audio processing steps involving decimation and/or replication only to parts of the system where non-audio data is simply not present, i.e., remote from the transmission stage.

FIG. 1 shows an HDMI receiver 210 according to the prior art. In the HDMI receiver 210, digital audio output data is emitted from the HDMI receiver 210 through an I2S output formatter and a SPDIF output formatter 240. The audio output sample frequency is constant and determined by the N and CTS parameters found in an Audio Clock Regeneration Packet (see HDMI spec 1.2, section 5.3.3). The audio sample data arrives at a variable rate in Audio Sample Packets (see HDMI spec 1.2, section 5.3.4) into a packet decoder 250. A FIFO 260 is implemented between packet decoder 250 and the output formatter stages 230 and 240.

If the throughput through the HDMI receiver 210 is not balanced, i.e., the input data arrives at a higher or lower rate, respectively, than the output data, the FIFO 260 will get full or empty, respectively. Thus the continuity of the output audio data will be disrupted, resulting in an audible interruption of sound.

To prevent this, flow adjustment is implemented in control logic of the FIFO 260. In normal operation, write and read pointers advance by 1 per each write and read operation, and the average distance between write and read pointer (AKA fill level) is constant, typically around “half full”. When the fill level of the FIFO 260 is above an “almost full” threshold, the read pointer will advance by 2 per read operation, effectively decimating the output data by a factor 2, until the fill level goes back below the threshold. When the fill level of the FIFO 260 is below an “almost empty” threshold, the read pointer will advance only every other read operation, effectively over sampling the output data by a factor 2, until the fill level goes back above the threshold.

Experimental data shows that the flow adjustment produces no audible side effects through the I2S output formatter 230, as long as the throughput misbalance is small (e.g. 44.107 KHz versus 44.103 KHz). However, experimental data shows that the flow adjustment produces a problem for the output of the SPDIF output formatter 240 (SPDIF output). The SPDIF output is organized in frames consisting of 192 audio samples each. Each audio sample has an associated channel status bit (see IEC60958-1 section 4 and IEC 60958-3 table 1). The 192 channel status bits essentially serve as an audio mode descriptor, wherein bits at specific positions (ranging from 0 to 192) have specific meanings. By decimating or duplicating audio samples, the associated channel status bits are decimated or duplicated as well, thus destroying the integrity of a frame. This results in an audible interruption of the audio stream through SPDIF, possibly without recovery.

Accordingly, it is desirable to provide a scheme that preserves control information embedded in digital data that handles the data in real time and transparently without requiring user intervention.

### SUMMARY OF THE INVENTION

Control information embedded in digital data is preserved by inputting digital data into a data processor, wherein the digital data includes real-time samples of recorded data and control information, the control information being organized in a format within the digital data, separating at least some of the control information from the recorded data, and storing the separated control information in a memory so that it is preserved.

### BRIEF DESCRIPTION OF THE DRAWINGS

The following drawings provide examples of the invention. However, the invention is not limited to the precise arrangements, instrumentalities, scales, and dimensions shown in these examples, which are provided mainly for illustration purposes only. In the drawings:

FIG. 1 is a schematic block diagram of a prior art HDMI receiver.

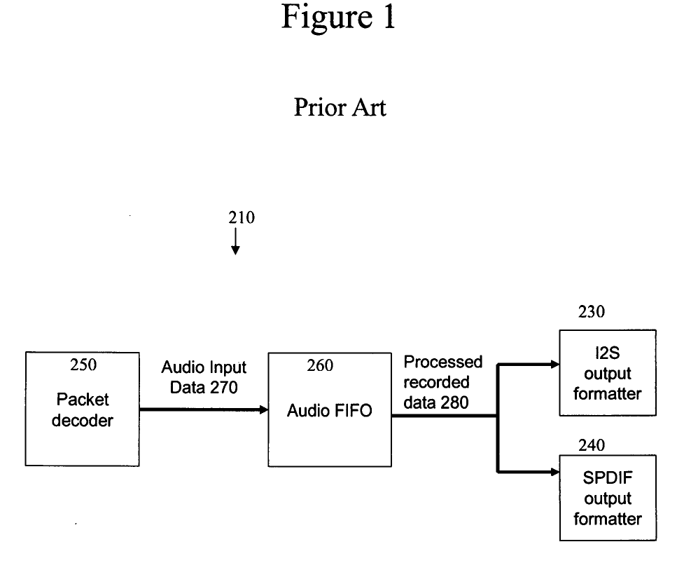

FIG. 2 is a schematic block diagram of an HDMI receiver that preserves control information embedded in digital data in accordance with a preferred embodiment of the present invention.

### DETAILED DESCRIPTION OF THE INVENTION

### 1. Overview

The present invention enables the deployment of audio processing steps involving decimation and/or replication anywhere in the system without imposing constraints, such as restricting the use of SPDIF output or restricting the use of decimation/replication between transmitter and receiver.

If systematic data decimation/replication is a requirement, the present invention is more convenient and easier to implement than software-controlled restitution of the non-audio data, because (1) no software has to be written, and (2) no redundancy is required, i.e., the data need not be present in any other media besides in the transmitted data.

Other than systematic data decimation/replication (e.g., for format conversions), dynamic data decimation/replication may also be required to handle data overflow/underflow. In such a scenario, there is a temporary misbalance between incoming and outgoing data, and a flow regulation mechanism needs to be used. The flow regulation mechanism must perform the following functions:
1. detect whether the incoming data rate is too high or too low to accommodate a data output with a constant rate,
2. decimate data in case the incoming data rate is too high,
3. replicate data in case the incoming data rate is too low,
4. revert to the normal data throughput when there is no more misbalance.
   Software control may be too slow to support dynamic flow regulation, or it might not be suitable for other reasons. The present invention can be implemented as a hardware control which would be more reliable than software and would not require user control.

### 2. Detailed Disclosure

An HDMI receiver according to the present invention separates the data path for the audio samples and the channel status bits, relying on the fact that the channel status bits carry information associated with the audio mode only, which is independent of a particular audio sample. Therefore, the channel status bits can be extracted upstream of the FIFO and then re-inserted downstream of the FIFO.

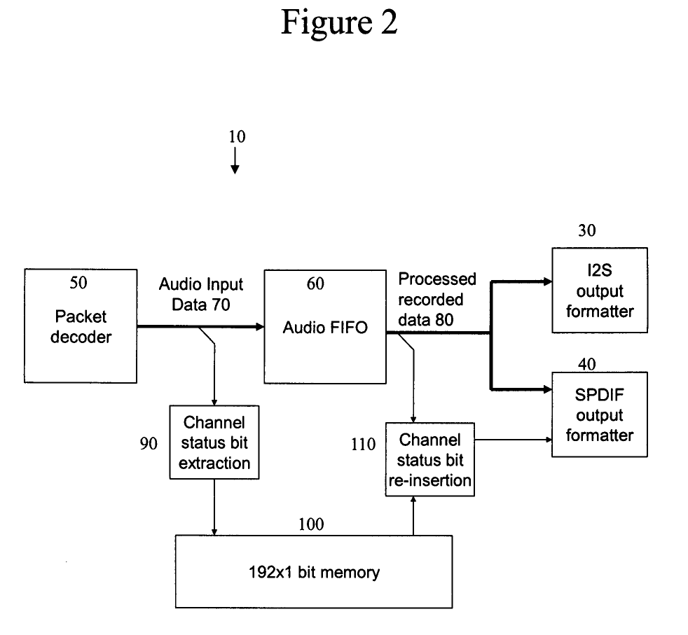

FIG. 2 shows an HDMI receiver 10 according to one embodiment of the present invention. The HDMI receiver 10 includes a packet decoder 50 that decodes digital input data 70. The digital input data 70 may be audio data, video data, digital measurement data, or any other type of digital data. The digital input data 70 includes recorded data and control information. The recorded data may include digital audio data. The control information includes a channel status bit and a parity bit. The control information is organized in a format within the digital input data 70. The HDMI receiver 10 further includes a control information extractor 90 that separates the control information from the recorded data. The HDMI receiver 10 further includes a memory 100 that stores the control information so that it is preserved. The HDMI receiver 10 further includes a data processor 60, such as an audio FIFO, that receives the recorded data as input and then processes the recorded data after the separation of the control information from the recorded data. The data processor 60 processes the recorded data by decimating (downsampling) and/or replicating (upsampling) the recorded data. The HDMI receiver 10 further includes a data combiner 110 that re-combines the stored control information with the processed recorded data into modified digital data. Additionally, the data combiner 110 recalculates the parity bit. Thus, the format in which the control information is organized in the modified digital data is the same as the format in which the control information is organized in the digital input data. The HDMI receiver 10 further includes at least one output that outputs the modified digital data 40, which may be an SPDIF output formatter. The HDMI receiver 10 further includes at least one output 30 that outputs the processed recorded data, which may be an I2S output formatter.

To further explain the present invention, the relations between IEC 60958 and HDMI format definitions for digital audio data are defined in Table 1 below.

TABLE 1
1 IEC 60958 block = 192 IEC 60958 frames
1 IEC 60958 frame = 2 IEC 60958 sub-frames
1 IEC 60958 sub-frame = 32 time slots
Time slot 0 . . . 3 = preamble
Time slot 4 . . . 27 = main data = HDMI Audio Sample Subpacket
L.4 . . . L.27 or R.4 . . . R.27
Time slot 28 = V (validity bit)
Time slot 29 = U (user bit)
Time slot 30 = C (channel status bit)
Time slot 31 = P (parity bit)
For linear PCM:
Time slot 4 . . . 7 = Aux
Time slot 8 . . . 27 = Audio sample word
1 HDMI Audio Sample Packet = 4 HDMI Audio Sample Subpackets
Therefore:
1 IEC 60958 sub-frame = 24 bit audio data + 4 bit PCUV data
1 HDMI Audio Sample Subpacket = 48 bit audio data + 8 bit PCUV data
1 HDMI Audio Sample Subpacket = 2 IEC 60958 sub-frames =
1 IEC 60958 frame
48 HDMI Audio Sample Packets = 192 IEC 60958 frames =
1 IEC 60958 block

An Audio Sample Packet (ASP) consists of 4 subpackets. At the write and read data ports of the Audio FIFO, the data is arranged as a 56 bit word according Table 2 below.

TABLE 2

| Bit # | Contents |
|---|---|
| 55 | Parity bit (even parity) |
| 54 | Channel status bit, 2nd sub-frame |
| 53 | User bit, 2^{nd} sub-frame |
| 52 | Validity bit, 2^{nd} sub-frame |
| 51:28 | Audio sample word (20 bit) + Aux (4 bit), 2^{nd} sub-frame |
| 27 | Block start indicator bit |
| 26 | Channel status bit, 1^{st} sub-frame |
| 25 | User bit, 1^{st} sub-frame |
| 24 | Validity bit, 1^{st} sub-frame |
| 23:0 | Audio sample word (20 bit) + Aux (4 bit), 1^{st} sub-frame |

Each subpacket contains data for both the 1^{st} and the 2^{nd} IEC60958 sub-frame. The 1^{st} and 2^{nd} sub-frames are associated with the left and right speaker in stereo mode.

In frame regeneration mode, bit 55, 54, 27, and 26 are extracted and re-inserted. The frame regeneration mode can be enabled by a software-programmable register. When frame regeneration is disabled, all bits are taken from the FIFO.

The following algorithms show an implementation of one preferred embodiment of portions of the above invention. On the FIFO write port, an address counter (channel_status_addr) is implemented. The address counter is synchronized using the block start indicator bits from the ASP header (see HDMI spec 1.2, section 5.3.4, table 5-12). These bits (b_0, b_1, b_2, b_3) indicate whether any of the 4 subpackets contains the 1^{st} frame in an IEC 60958 block. The synchronization mechanism also uses the existing write control signals (wr, aspf_inc) of the FIFO.

```
wire  block_start = b_0 || b_1 || b_2 || b_3;
reg  [7:0] channel_status_addr;
always @(posedge clk or negedge rstn) begin
    if (!rstn) channel_status_addr <= 8′d0;
    else if (aspf_inc && block_start) channel_status_addr <= 8′d0;
    else if (wr && channel_status_addr < 8′d192)
channel_status_addr <= channel_status_addr + 1′d1;
end
```

For proper alignment between control and data signals, the channel status bits at the FIFO data port (spm[26], spm[54]) are delayed by one clock cycle.

```
reg  cl_bit,cr_bit;
always @(posedge clk or negedge rstn) begin
    if(!rstn) {cl_bit,cr_bit} <= 2′b0;
    else {cl_bit,cr_bit} <= {spm[26],spm[54]};
end
```

The extracted channel status bits (cl_bit, cr_bit) are then stored in a 192 bit wide memory, one associated with the 1^{st} subframe (channel_status_left), the other associated with the 2^{nd} subframe (channel_status_right).

```
reg  [191:0] channel_status_left,channel_status_right;
always @(posedge clk or negedge rstn) begin
    if (!rstn) {channel_status_left,channel_status_right} <= 192′b0;
    else if (wr) begin
        channel_status_left[channel_status_addr] <= cl_bit;
        channel_status_right[channel_status_addr] <= cr_bit;
    end
end
```

On the FIFO read port, a free-running modulo 192 counter (rd_count) is implemented. The counter is controlled by the existing read enable signal (rd) of the FIFO.

```
reg  [7:0] rd_count;
always @(posedge afclk or negedge rstn) begin
    if (!rstn) rd_count <= 8′d0;
    else if (rd) rd_count <= (rd_count < 8′d191)? rd_count +
    1′d1 : 8′d0;
end
```

The block start indicator bit (b_rd) and the parity bit (p_rd) are regenerated and re-inserted into the data bus (rd_datao) together with the channel status bits (cl_rd, cr_rd). This function is enabled or disabled by a programmable register (flow_dt_en).

wire cl_rd = channel_status_left [rd_count];
wire cr_rd = channel_status_right[rd_count];
wire b_rd = (rd_count==8′d0);
wire p_rd = \hat{ }{cr_rd,rd_data[53:28],b_rd,cl_rd,rd_data[25:0]};
assign rd_datao = flow_dt_en?
{p_rd,cr_rd,rd_data[53:28],b_rd,cl_rd,rd_data[25:0]} :
rd_data[55:0];

It will be appreciated by those skilled in the art that changes could be made to the embodiments described above without departing from the broad inventive concept thereof. It is understood, therefore, that this invention is not limited to the particular examples disclosed, but it is intended to cover modifications' within the spirit and scope of the present invention as defined by the appended claims.

What is claimed is:

1. A method of preserving control information embedded in digital data comprising:
inputting digital data into a data processor, the digital data including real-time samples of recorded data and control information, the control information being organized in a format within the digital data;
separating at least some of the control information from the recorded data;
storing the separated control information in a memory so that it is preserved;
processing the recorded data in the data processor;
re-combining the stored control information with the processed recorded data into modified digital data such that the format in which the control information was organized is preserved in the modified digital data; and
outputting the modified digital data, the modified digital data including the stored control information.

2. (canceled)

3. The method of claim 1, wherein the recorded data comprises digital audio data, and the recorded data is processed by an audio FIFO.

4. The method of claim 1, wherein the processing of the recorded data comprises decimation (downsampling) of at least some of the recorded data.

5. The method of claim 1, wherein the processing of the recorded data comprises replication (upsampling) of at least some of the recorded data.

6. The method of claim 1, further comprising:
outputting the processed recorded data.

7. The method of claim 1, wherein the recorded data comprises digital audio data.

8. The method of claim 1, wherein the recorded data comprises digital video data.

9. The method of claim 1, wherein the recorded data comprises digital measurement data.

10. The method of claim 1, wherein the control information comprises a channel status bit.

11. The method of claim 1, further comprising:
inputting the inputted digital data from a packet decoder.

12. An apparatus for preserving control information embedded in digital data comprising:
an input that inputs digital data into a data processor, the digital data including recorded data and control information, the control information being organized in a format within the digital data, wherein the data processor further processes the recorded data after the separation of the control information from the recorded data;
a control information extractor that separates the control information from the recorded data;
memory that stores the control information so that it is preserved;
a data combiner that re-combines the stored control information with the processed recorded data into modified digital data such that format in which the control information was organized is preserved in the modified digital data; and
an output that outputs the modified digital data, the modified digital data including the stored control information.

13. (canceled)

14. The apparatus of claim 12, wherein the recorded data comprises digital audio data, and the recorded data is processed by an audio FIFO.

15. The method of claim 12, wherein the data processor decimates (downsamples) some of the digital data.

16. The method of claim 12, wherein the data processor replicates (upsamples) some of the digital data.

17. The method of claim 12, further comprising:
an output that outputs the processed recorded data.

18. The apparatus of claim 12, wherein the recorded data comprises digital audio data.

19. The apparatus of claim 12, wherein the recorded data comprises digital video data.

20. The apparatus of claim 12, wherein the recorded data comprises digital measurement data.

21. The apparatus of claim 12, wherein the control information comprises a channel status bit.

22. The method of claim 12, wherein the input that inputs digital data is a packet decoder.
